(19) United States
(12) Patent Application Publication
(10) Pub. No.: US 2020/0034870 A1
(43) Pub. Date: Jan. 30, 2020

(54) SYSTEMS AND METHODS FOR OUT-OF-BAND, TIME-BASED MATCHING FOR APPLYING ISSUER BENEFITS TO TRANSACTIONS

(71) Applicant: JPMORGAN CHASE BANK, N.A., New York, NY (US)

(72) Inventors: Tuan DAO, Richardson, TX (US); Raymond H. BROWN, JR., Wilmington, DE (US); Sangameswara Rao PANCHOMARTHI, Bear, DE (US); Howard SPECTOR, Woolwich, NJ (US); Ryan EVANS, Prosper, TX (US); Joshua D. PETERS, Dallas, TX (US); Mizan MIAH, Wilmington, DE (US)

(21) Appl. No.: 16/521,059

(22) Filed: Jul. 24, 2019

Related U.S. Application Data
(60) Provisional application No. 62/703,164, filed on Jul. 25, 2018.

(51) Int. Cl. G06Q 30/02; G06Q 20/40; G06Q 20/36

(52) U.S. Cl. CPC G06Q 30/0235; G06Q 30/0233; G06Q 20/3674; G06Q 20/401

(57) ABSTRACT

Systems and methods for out-of-band, time-based matching for applying issuer benefits to a transaction are disclosed. In one embodiment, in an issuer authorization platform comprising at least one computer processor, a method for out-of-band, time-based matching for applying issuer benefits to a transaction may include: (1) receiving, from a computer application executed by an electronic device and over a communication network, a payment option to apply to a transaction conducted with a merchant; (2) receiving, from a payment network, an authorization request for the transaction from the merchant; (3) matching the payment option to the authorization request when the payment option and the authorization request are received within a predetermined time of each other; and (4) applying the payment option to the transaction.

### RELATED APPLICATIONS

This application claims the benefit and priority of U.S. patent application Ser. No. 62/703,164, filed Jul. 25, 2018, the disclosure of which is hereby incorporated, by reference, in its entirety.

### BACKGROUND OF THE INVENTION

### 1. Field of the Invention

The present disclosure generally relates to systems and methods for out-of-band, time-based matching for applying issuer benefits, such as an issuer-specific payment option, to a transaction.

### 2. Description of the Related Art

Third-party wallets conducting payment transactions based on industry standards such as EMV, MSD (mag stripe), or MST (Magnetic Secure Transmission) do not have a mechanism for Issuers to apply certain benefits or alternative forms of currency. To enable this capability would require changes to how third-party wallets conduct transactions, how merchants receive payments, acquirers/processors process transactions and how payment networks (e.g., Visa, MasterCard, etc.) validate transactions and interact with Issuers.

### SUMMARY OF THE INVENTION

Systems and methods for out-of-band, time-based matching for applying issuer benefits to a transaction are disclosed. In one embodiment, in an issuer authorization platform comprising at least one computer processor, a method for out-of-band, time-based matching for applying issuer benefits to a transaction may include: (1) receiving, from a computer application executed by an electronic device and over a communication network, a payment option to apply to a transaction conducted with a merchant; (2) receiving, from a payment network, an authorization request for the transaction from the merchant; (3) matching the payment option to the authorization request when the payment option and the authorization request are received within a predetermined time of each other; and (4) applying the payment option to the transaction.

In one embodiment, the electronic device may include a mobile electronic device, and the computer application is a mobile payment application.

In one embodiment, the payment option is to pay with points, to pay with an alternative currency, etc.

In one embodiment, the communication network may be the Internet.

In one embodiment, the method may further include matching a token or a token reference identifier received with the payment option to a token or a token reference identifier received with the authorization request.

In another embodiment, in an issuer authorization platform comprising at least one computer processor, a method for out-of-band, time-based matching for applying issuer benefits to a transaction may include: (1) receiving, from a computer application executed by an electronic device and over a communication network, a payment option to apply to a transaction conducted with a merchant, wherein a first timestamp is associated with the payment option; (2) receiving, from a payment network, an authorization request for the transaction from the merchant, wherein a second timestamp is associated with the authorization request; (3) matching the payment option to the authorization request when the first timestamp and the second timestamp are within a predetermined time of each other; and (4) applying the payment option to the transaction.

In one embodiment, the electronic device may be a mobile electronic device, and the computer application may be a mobile payment application.

In one embodiment, the payment option is to pay with points, to pay with an alternative currency, etc.

In one embodiment, the communication network may be the Internet.

In one embodiment, the method may further include matching a token or a token reference identifier received with the payment option to a token or a token reference identifier received with the authorization request.

In one embodiment, the first timestamp may be based on a time that the computer application communicates the payment option. The second timestamp may be based on a time that the computer application communicates the transaction to the merchant, may be based on a time that the authorization request is received by the payment network, etc.

According to another embodiment, a system for out-of-band, time-based matching for applying issuer benefits to a transaction may include an electronic device executing a computer application; an issuer authorization platform; and a payment network. The issuer authorization platform may receive a payment option to apply to a transaction conducted with a merchant from the computer application over a communication network, may receive an authorization request for the transaction from the payment network, may match the payment option to the authorization request when the payment option and the authorization request are received within a predetermined time of each other, and may apply the payment option to the transaction.

In one embodiment, the issuer authorization platform may match a token or a token reference identifier received with the payment option to a token or a token reference identifier received with the authorization request.

In one embodiment, the payment option is to pay with points, to pay with an alternative currency, etc.

In one embodiment, the payment option may be associated with a first timestamp, and the authorization request may be associated with a second timestamp.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 depicts a system for out-of-band, time-based matching for applying issuer benefits to a transaction according to one embodiment;

FIG. 2 depicts a method for out-of-band, time-based matching for applying issuer benefits to a transaction according to one embodiment; and

FIG. 3 depicts an exemplary timing diagram of payment instruction and authorization requests arriving at an issuer authorization platform according to one embodiment.

### DETAILED DESCRIPTION OF PREFERRED EMBODIMENTS

Embodiments are generally directed to systems and methods for out-of-band, time-based matching for applying issuer benefits to a transaction. In embodiments, methods may communicate separate issuer-specific instruction out-of-band and substantially in parallel with a standard authorization request from the point of transaction initiation. Both will arrive at the Issuer's authorization platform where the transaction and the instruction are matched and combined.

In embodiments, when a transaction (e.g., NFC, Bluetooth, optical, Wi-Fi, beacon, etc.) initiates from a mobile payment application (e.g., Chase Pay), the mobile payment application may inform the issuer's payment systems of the user's election to use a payment option (e.g., pay with points (PwP), discounts, alternate currencies, crypto-currencies, etc.) independent of the transaction payload. To do this, the electronic device executing the mobile payment application may use a data connection with the issuer, and the user may be required to be logged into the mobile payment application so that the issuer may retrieve information from the issuer (e.g., pay with points information, such as points balance) from the issuer's systems (e.g., an authorization platform).

In one embodiment, the following information may be necessary for the issuer's backend to post-match the transaction: (1) the user's election to use the payment option (e.g., PwP, alternate currency, crypto-currency, etc.); (2) a time stamp for the transaction; and (3) a way to identify the token used in the transaction. For Android OS mobile payment applications, the mobile payment application knows the token used for transaction, and a unique token may be provided for each device. For iOS, only Apple knows the token, but can return a token reference identifier to the mobile payment application during provisioning. The token reference identifier may be associated with the token and may be stored in the token vault at provisioning.

In addition to these three pieces of information, an Android OS-based mobile payment application may generate the cryptogram on the mobile device, and then communicate the cryptogram to the issuer's backend to further enhance matching. iOS devices and applications do not share the cryptogram with the mobile payment application, so it is not available.

Although the disclosure is made in the context of mobile electronic devices, it should be recognized that other electronic devices, including web-based devices, smart devices, Internet of Things devices, etc. may be used as is necessary and/or desired.

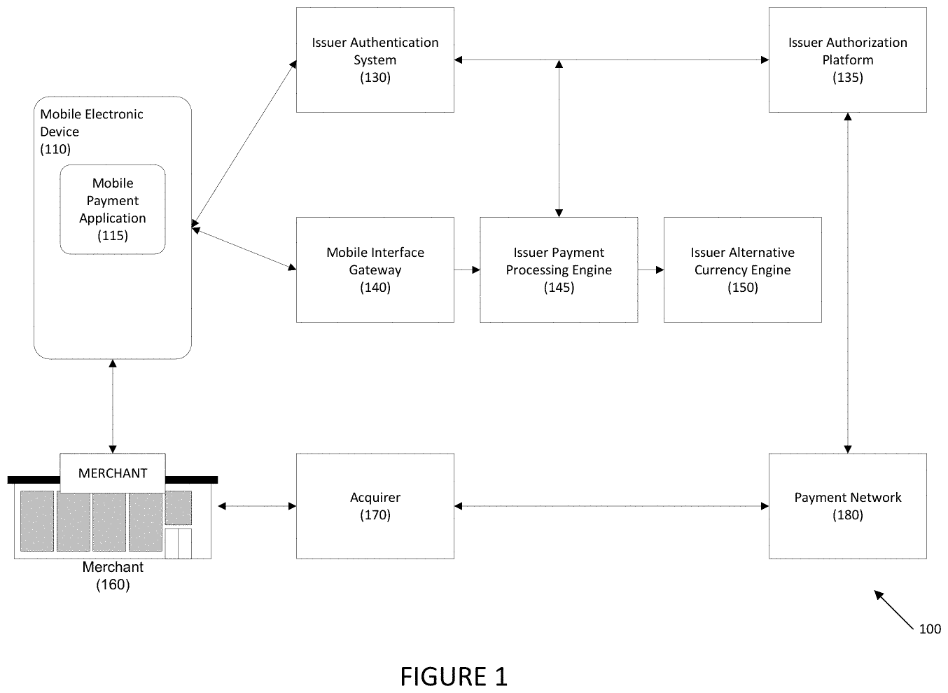

Referring to FIG. 1, a system for out-of-band, time-based matching for applying issuer benefits to a transaction is disclosed according to one embodiment. System 100 may include mobile electronic device 110, which may be any suitable mobile electronic device, such as a smart phone, smart watch, smart ring, Internet of Things (IoT) appliance, etc. Mobile electronic device 110 may execute mobile payment application 115, which may be provided by a financial institution, such as an issuer of a credit card.

In one embodiment, the financial institution may further provide a non-standard or alternative payment currency, such as reward points, cryptocurrency, lines of credit, etc. Any other non-standard or alternative payment currencies may be involved as is necessary and/or desired.

Mobile payment application 115 may permit a user to select a payment option, such as an issuer-specific payment option to use a non-standard or alternative payment currency for the transaction. Examples include PwP, discounts, cryptocurrencies, etc. In one embodiment, a toggle button or other selection mechanism may be used to select the payment option.

Mobile payment application 115 may interact with merchant 160, which may be any suitable provider of a good or service. Merchant 160 may be an online merchant, a brick-and-mortar merchant, etc. Merchant 160 may provide a point of transaction, such as a point of sale device, for communication with mobile electronic device 110.

In one embodiment, mobile payment application 115 may communicate payment information to merchant 160 using, for example, near field communication (NFC) or a similar wireless communication channel. In another embodiment, mobile payment application 115 may communicate payment information to merchant 160 using, for example, a machine-readable code, such as a QR code.

Merchant 160 may interface with acquirer 170, which may interface with issuer authorization platform 135 for the issuing financial institution. In one embodiment, the interaction between merchant 160, acquirer 170, payment network 180, and issuer authorization platform 135 may be a standard payment authentication channel.

Mobile payment application 115 may further interface with issuer authentication system 130 and mobile interface gateway 140 for the issuing financial institution. In one embodiment, the communications between mobile payment application 115, issuer authentication system 130, and mobile interface gateway 140 may be over a different communication channel than that used by merchant 160 to authorize a transaction with issuer authorization platform 135. For example, mobile payment application 115, issuer authentication system 130, and mobile interface gateway 140 may communicate over a data channel, such as the Internet.

Issuer authentication system 130 may be used to authenticate a user that is logging into the mobile payment application. In one embodiment, issuer authentication system 130 may use a username and password, biometrics, out-of-band authentication, etc. to authenticate the user as is necessary and/or desired.

Mobile interface gateway 140 may receive the payment option selection from mobile payment application 115. In one embodiment, it may further receive other transaction information, such as a token, a token reference identifier, etc. The information that is provided may depend on mobile device 110′s platform. Other information may be provided as is necessary and/or desired.

Issuer payment processing engine 145 may receive the payment option selection, and may interface with issuer systems, such as alternative currency engine 150, to implement the payment option selection. For example, issuer payment processing engine 145 may retrieve a reward point balance from issuer alternative currency engine 150, such as an issuer rewards engine, if the payment option selection is PwP. Issuer payment processing engine 145 may interface with any other suitable system, both internal and third-party systems, as is necessary and/or desired.

For example, issuer payment processing engine 145 may process whatever the alternate currency the Issuer accepts, and issuer alternative currency engine 150 applies the transaction to the user's account.

Issuer authorization platform 135 may perform standard transaction authorization for transactions received from payment network 180. It may further receive the payment option selection and other identifying information (e.g., token reference number, timestamp, etc.) and may implement logic to match the transaction authorization request (e.g., the token or token reference identifier and time stamp) against the payment option selection (e.g., PwP) using, for example, a token or token reference identifier and the time stamp.

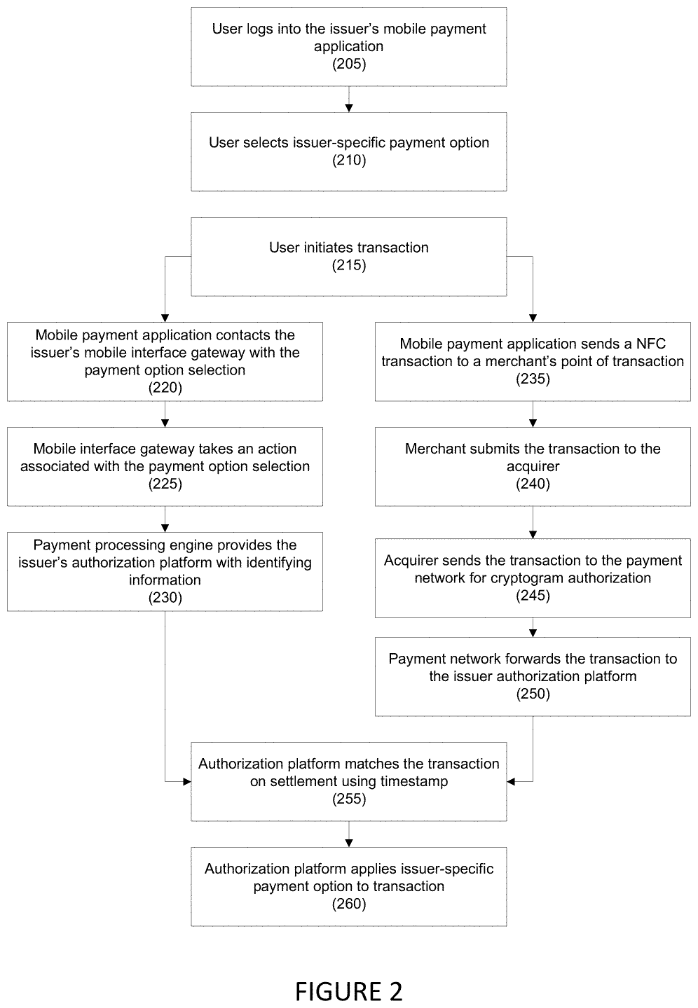

Referring to FIG. 2, a method for out-of-band, time-based matching for applying issuer benefits to a transaction is disclosed according to one embodiment. It should be noted that although specific devices, systems, and entities may be referenced in the description of this figure, these are exemplary only and are not limiting to this disclosure.

In step 205, a user may log into the issuer's mobile payment application (e.g., Chase Pay) using, for example, the issuer's authentication service, and, in step 210, may select a payment option selection (e.g., PwP, alternate currency, crypto-currency, etc.). In one embodiment, the payment option selection may be selected from within the mobile payment application.

In step 215, the user may initiate the transaction by selecting “Tap to Pay,” selecting a “Pay Now” button, or taking another payment initiation action. This may initiate the transaction with the merchant, and may also initiate the out-of-band communication of the payment option selection with the mobile interface gateway.

In step 220, the mobile payment application may contact the issuer's mobile interface gateway with the payment option selection. In one embodiment, the mobile payment application may further provide a token or a token reference identifier with the communication. Any additional information may be provided as is necessary and/or desired.

In step 225, the mobile interface gateway may take an action associated with the payment option selection, such as retrieving the customer's point balance if a PwP transaction is selected. If a different payment option is selected, appropriate issuer systems and/or third-party systems may be accessed to facilitate the execution of the selected payment option.

In step 230, the payment processing engine may provide the issuer's authorization platform with identifying information (e.g., the token or token reference identifier, a timestamp, a transaction location, etc.). In addition, the payment processing engine may provide information on the payment option selection, such as the number of points available, authorization for the PwP transaction, authorization for an alternative currency transaction, etc.

In one embodiment, one or more timestamp may be applied when the payment option is selected, when the payment option is communicated to the gateway, when the payment option is received by the issuer, etc. In one embodiment, the payment option may be associated with a plurality of timestamps.

In step 235, the mobile payment application may send a transaction (e.g., a NFC transaction) to a merchant's point of transaction (e.g., a point of sale terminal). In another embodiment, the mobile payment application may present a machine-readable code, such as a QR code, to be presented to the merchant point of transaction. Other similar mechanisms for communicating payment information to the merchant may be used as is necessary and/or desired.

In one embodiment, a certain amount of time may be required to prepare for the NFC or other communication to the point of transaction device. For example, there may be a time required for the mobile payment application to retrieve a payment token from secure storage of the mobile electronic device, to communicate the payment information, and to conduct the transaction.

In one embodiment, the transaction may be associated with one or more timestamps. In one embodiment, one or more timestamp may be applied when the transaction is initiated by the mobile application, when the transaction is communicated to the merchant POS, when the transaction is received by the payment network, when the transaction is received by the issuer, etc. In one embodiment, the transaction may be associated with a plurality of timestamps.

In another embodiment, the transaction may be associated with a location, such as a merchant location, an electronic device location, etc.

In step 240, the merchant may submit the transaction to the acquirer, which, in step 245, may then send the transaction to a payment network (e.g., VisaNet) for cryptogram authorization. The payment network may validate the cryptogram.

In step 250, the payment network may forward the transaction to the issuer authorization platform. In one embodiment, this may include the timestamp for the transaction.

Steps 235, 240, 245, and 250 may be performed in a conventional manner. Thus, none of the merchant, the acquirer, or the payment network need know that the transaction will be settled using the payment option selection.

In one embodiment, steps 220, 225, and 230 may be performed substantially in parallel with steps 235, 240, 245, and 250. In embodiments, however, the payment option selection will most likely be received by the issuer authorization platform before the transaction is received from the payment network. Thus, to minimize race conditions, the payment option selection may be required to be synchronous. For example, the mobile payment application may wait for an acknowledgement of the payment option selection from the issuer backend before initiating the transaction with the merchant.

If the mobile payment application does not receive confirmation that the payment option selection was received, it may inform the user that the selected payment option is unavailable, will not be applied to this transaction, etc.

In step 255, the issuer authorization platform may receive both the transaction from the payment network and the payment option selection from the payment processing engine, and may match the transaction from the payment network with the payment option selection. In one embodiment, the issuer authorization platform may identify transactions that were received a substantially the same time. For example, a time difference between the receipt of the transaction authorization and the payment option selection (e.g., PwP), Δƒ, may be allowed for matching purposes. In one embodiment, Δƒ may be less than a few seconds; the length of Δƒ may be selected as is necessary and/or desired.

In one embodiment, a transaction from the payment network may be matched to the payment option selection received from the payment processing engine that has falls within the Δƒ time difference.

In one embodiment, once the timing or timestamps are matched, the token or token reference identifier with the payment option selection may be verified to be the same as the token provided with the authorization request. This may be an optional step.

In another embodiment, in addition to, or instead of, time-based matching, location-based matching may be used to match the location associated with the transaction received over the payment network to the location associated with the payment option selection.

In step 260, the issuer authorization platform may apply the payment option selection to the transaction. For example, if PwP is selected, the appropriate points may be deducted from the customer's points balance. If an alternative currency is selected, the issuer may use the alternative currency to conduct the transaction.

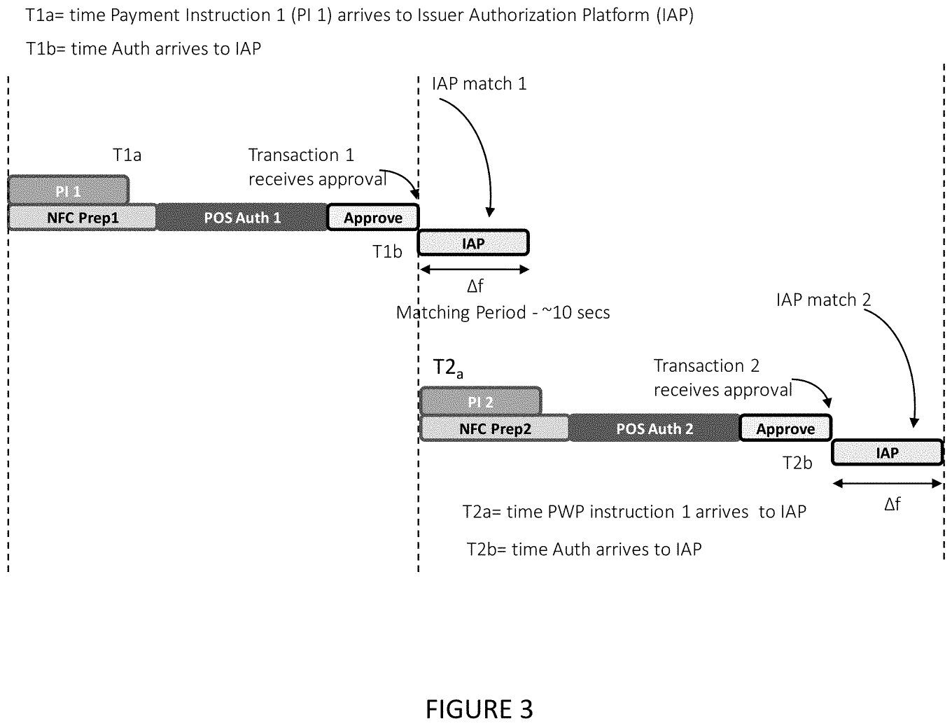

Referring to FIG. 3, an example of transaction matching is disclosed according to one embodiment. FIG. 3 illustrates the timing of two transactions, T1 and T2, arriving at the issuer authorization platform (IAP). T1ₐ represents the time that the payment instruction for Transaction 1 arrives at the IAP, and T1_{b} represents the time that the authorization request arrives at the IAP. If T1ₐ and T1_{b} fall within the Δƒ time difference, the IAP will match the payment instruction for T1 with the authorization request for T1. A similar illustration is provided for Transaction 2 (T2).

Although multiple embodiments may have been described, it should be recognized that these embodiments are not exclusive, and that features from one may be applied to others.

Hereinafter, general aspects of implementation of the systems and methods of the invention will be described.

The system of the invention or portions of the system of the invention may be in the form of a “processing machine,” such as a general purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement the invention may be a general purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

The processing machine used to implement the invention may utilize a suitable operating system. Thus, embodiments of the invention may include a processing machine running the iOS operating system, the OS X operating system, the Android operating system, the Microsoft Windows™ operating systems, the Unix operating system, the Linux operating system, the Xenix operating system, the IBM AIX™ operating system, the Hewlett-Packard UX™ operating system, the Novell Netware™ operating system, the Sun Microsystems Solaris™ operating system, the OS/2™ operating system, the BeOS™ operating system, the Macintosh operating system, the Apache operating system, an OpenStep™ operating system or another operating system or platform.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further embodiment of the invention, be performed by a single component. Further, the processing performed by one distinct component as described above may be performed by two distinct components. In a similar manner, the memory storage performed by two distinct memory portions as described above may, in accordance with a further embodiment of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity; i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the invention. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instruction or single programming language be utilized in conjunction with the operation of the system and method of the invention. Rather, any number of different programming languages may be utilized as is necessary and/or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors of the invention.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention.

Accordingly, while the present invention has been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method for out-of-band, time-based matching for applying issuer benefits to a transaction, comprising:
in an issuer authorization platform comprising at least one computer processor:
receiving, from a computer application executed by an electronic device and over a communication network, a payment option to apply to a transaction conducted with a merchant;
receiving, from a payment network, an authorization request for the transaction from the merchant;
matching the payment option to the authorization request when the payment option and the authorization request are received within a predetermined time of each other; and
applying the payment option to the transaction.

2. The method of claim 1, wherein the electronic device comprises a mobile electronic device, and the computer application is a mobile payment application.

3. The method of claim 1, wherein the payment option is to pay with points.

4. The method of claim 1, wherein the payment option is to pay with an alternative currency.

5. The method of claim 1, wherein the communication network is the Internet.

6. The method of claim 1, further comprising:
matching a token or a token reference identifier received with the payment option to a token or a token reference identifier received with the authorization request.

7. A method for out-of-band, time-based matching for applying issuer benefits to a transaction, comprising:
in an issuer authorization platform comprising at least one computer processor:
receiving, from a computer application executed by an electronic device and over a communication network, a payment option to apply to a transaction conducted with a merchant, wherein a first timestamp is associated with the payment option;
receiving, from a payment network, an authorization request for the transaction from the merchant, wherein a second timestamp is associated with the authorization request;
matching the payment option to the authorization request when the first timestamp and the second timestamp are within a predetermined time of each other; and
applying the payment option to the transaction.

8. The method of claim 7, wherein the electronic device comprises a mobile electronic device, and the computer application is a mobile payment application.

9. The method of claim 7, wherein the payment option is to pay with points.

10. The method of claim 7, wherein the payment option is to pay with an alternative currency.

11. The method of claim 7, wherein the communication network is the Internet.

12. The method of claim 7, further comprising:
matching a token or a token reference identifier received with the payment option to a token or a token reference identifier received with the authorization request.

13. The method of claim 7, wherein the first timestamp is based on a time that the computer application communicates the payment option.

14. The method of claim 7, wherein the second timestamp is based on a time that the computer application communicates the transaction to the merchant.

15. The method of claim 7, wherein the second timestamp is based on a time that the authorization request is received by the payment network.

16. A system for out-of-band, time-based matching for applying issuer benefits to a transaction, comprising:
an electronic device executing a computer application;
an issuer authorization platform; and
a payment network;
wherein:
the issuer authorization platform receives a payment option to apply to a transaction conducted with a merchant from the computer application over a communication network;
the issuer authorization platform receives an authorization request for the transaction from the payment network;
the issuer authorization platform matches the payment option to the authorization request when the payment option and the authorization request are received within a predetermined time of each other; and
the issuer authorization platform applies the payment option to the transaction.

17. The system of claim 16, wherein the issuer authorization platform matches a token or a token reference identifier received with the payment option to a token or a token reference identifier received with the authorization request.

18. The system of claim 16, wherein the payment option is to pay with points.

19. The system of claim 16, wherein the payment option is to pay with an alternative currency.

20. The system of claim 16, wherein the payment option is associated with a first timestamp, and the authorization request is associated with a second timestamp.
